(19) United States
(12) Patent Application Publication
(10) Pub. No.: US 2021/0308935 A1
(43) Pub. Date: Oct. 7, 2021

(54) RAPID MICROFEATURE FORMING SYSTEM

(71) Applicant: Parallel Fluidics, Stoneham, MA (US)

(72) Inventors: Joshua Gomes, Cambridge, MA (US); Andrew Harris, Somerville, MA (US); Emily Batt, Boston, MA (US)

(73) Assignee: Parallel Fluidics, Stoneham, MA (US)

(21) Appl. No.: 17/221,189

(22) Filed: Apr. 2, 2021

Related U.S. Application Data
(60) Provisional application No. 63/004,014, filed on Apr. 2, 2020.

(51) Int. Cl. B29C 59/02; B33Y 10/00; B33Y 80/00; B29C 64/124; B29C 33/38

(52) U.S. Cl. CPC B29C 59/022; B33Y 10/00; B33Y 80/00; B29K 2101/12; B29C 33/3842; B29C 2059/023; B29C 64/124

(57) ABSTRACT

Systems and methods for forming microfeatures in a chip. A microfeature mold may be formed from a thermally stable photopolymer using a three-dimensional (3D) printing process. The microfeature mold may include a first half having a cavity alignment feature and a recess and a second half having a microfeature pattern and a core alignment feature. A thermoplastic sheet may be placed within the recess. The thermoplastic sheet may be compressed between the first half and the second half of the microfeature mold using a compression apparatus. One or more of the first half of the microfeature mold and the second half of the microfeature mold may be heated to a temperature above the glass transition temperature of the thermoplastic sheet, thereby causing the compressed thermoplastic sheet to flow and one or more microfeatures to be formed.

### CROSS-REFERENCE TO RELATED APPLICATION

This application claims priority to U.S. Provisional Application Ser. No. 63/004,014, filed Apr. 2, 2020, the content of which is incorporated herein by reference in its entirety.

### TECHNICAL FIELD

The present disclosure generally relates to forming microfluidic chips through hot embossing, and, more particularly, a novel hot embossing process using a three-dimensional (“3D”) printed microfeature mold.

### BACKGROUND

Lab-on-chip technologies use microfluidics and electronics to scale down complicated laboratory processes into single devices, often smaller than a credit card. The miniaturization and automation afforded by these microfluidic chips has the potential to both decrease the cost and increase the reliability of point-of-care testing, DNA/RNA analysis, diagnostics, drug development, and many other fields, all of which play a significant role in understanding human health. While these lab-on-chip devices have many benefits for end users, the technology development process can be challenging and expensive. In particular, the manufacture of microfluidic prototypes is a major pain point for researchers. Accordingly, it may be desirable to develop a method of forming lab-on-chip devices that addresses the shortcomings of existing fabrication techniques.

### SUMMARY

The present disclosure provides components, systems and methods for forming microfeatures in a chip. A microfeature mold may be formed from a thermally stable photopolymer using a three-dimensional (3D) printing process. The microfeature mold may include a first half having a cavity alignment feature and a recess and a second half having a microfeature pattern and a core alignment feature. A thermoplastic sheet may be placed within the recess. The thermoplastic sheet may be compressed between the first half and the second half of the microfeature mold using a compression apparatus. One or more of the first half of the microfeature mold and the second half of the microfeature mold may be heated to a temperature above the glass transition temperature of the thermoplastic sheet, thereby causing the compressed thermoplastic sheet to flow and one or more microfeatures to be formed.

A system for forming microfeatures on a microfluidic chip may include a microfeature mold comprising a three-dimensional printed thermally stable photopolymer. A first half of the microfeature mold may include a recess and a cavity alignment feature. The recess may be configured to hold a thermoplastic sheet. A second half of the microfeature mold may include a microfeature pattern and a core alignment feature, the core alignment feature aligned with the cavity alignment feature. A compression apparatus may be coupled to one or more of the first half of the microfeature mold and the second half of the microfeature mold.

A method of forming microfeatures in a chip may include positioning a thermoplastic sheet within a recess of a first half of a microfeature mold. The microfeature mold may comprise a three-dimensional printed thermally stable photopolymer. A cavity alignment feature of the first half of the microfeature mold may be aligned with a core alignment feature of a second half of the microfeature mold. The thermoplastic sheet may be compressed, via a compression apparatus, between the first half of the microfeature mold and the second half of the microfeature mold, such that a microfeature pattern of the second half of the microfeature mold is imprinted on the thermoplastic sheet. One or more of the first half of the microfeature mold and the second half of the microfeature mold may be heated to a temperature above the glass transition temperature of the thermoplastic sheet, such that the compressed thermoplastic sheet flows within the microfeature pattern.

A three-dimensional printing method of forming a microfeature mold may include lowering a build platform into a resin tank containing a liquid photopolymer resin, such that the liquid photopolymer resin fills a predetermined gap between a transparent bottom plate of the resin tank and the build platform. A light may be emitted from an optical curing source below the transparent bottom plate in a first pattern based on a predetermined design to cure the liquid photopolymer resin and form a first layer of the microfeature mold. The first layer may comprise a thermally stable photopolymer. The build platform may be raised with respect to the transparent bottom plate, such that the liquid photopolymer resin fills a gap between the transparent bottom plate and the first layer of the microfeature mold. The light may be emitted from the optical curing source in a second pattern based on the predetermined design to cure the liquid photopolymer resin to and form a second layer of the microfeature mold. The second layer may also comprise the thermally stable photopolymer. The raising and emitting steps may be repeated until the microfeature mold is fully formed.

### BRIEF DESCRIPTION OF THE DRAWINGS

The drawings described below are for illustration purposes only. The drawings are not intended to limit the scope of the present disclosure.

FIG. 1 is a perspective view of a microfeature mold formed using a printing process;

FIG. 2 is a perspective view of core tooling;

FIG. 3 is an illustration of a three-dimensional (3D) printer that may be used to form the microfeature mold;

FIG. 4A is a side view of 3D-printed tooling of the microfeature mold formed flat against a build platform;

FIG. 4B is a side view of 3D-printed tooling of the microfeature mold formed orthogonal to the build platform;

FIG. 5A is a front section view of the microfeature mold in an open position;

FIG. 5B is a front section view of the microfeature mold in an open position with a thermoplastic sheet inserted into a recess;

FIG. 5C is a front section view of the microfeature mold in a partially closed position with the thermoplastic sheet inserted into the recess;

FIG. 6A is a magnified view of the microfeature mold in a partially closed position with the thermoplastic sheet inserted;

FIG. 6B is a magnified view of the microfeature mold in a fully compressed position with the thermoplastic sheet inserted;

FIG. 6C is a magnified view of the microfeature mold in an open position after the molding process is complete;

FIG. 6D is a magnified view of another example of the microfluidic mold in a partially closed state;

FIG. 6E is a magnified view of the microfluidic mold in a closed state;

FIG. 6F is a magnified view of the microfluidic mold in an open state;

FIG. 7 is a front section view of an example heating assembly;

FIG. 8 is a front elevational view of a first microfeature forming apparatus;

FIG. 9 is a front elevational view of a second microfeature forming apparatus;

FIG. 10 is a front elevational view of a third microfeature forming apparatus;

FIG. 11 is a front elevational view of a fourth microfeature forming apparatus;

FIG. 12 is a front elevational view of a fifth microfeature forming apparatus;

FIG. 13 is a perspective view of a formed chip resulting from the molding process;

FIG. 14 is a cross section view of a microfeature of the chip;

FIG. 15 is a flowchart illustrating a method of forming the microfluidic chip using the microfeature mold; and

FIG. 16 is a flowchart illustrating a method of forming the microfeature mold.

### DETAILED DESCRIPTION

The present disclosure is related to forming microfluidic chips through hot embossing, and, more particularly, a novel hot embossing process using a three-dimensional (“3D”) printed microfeature mold that addresses the shortcomings of existing fabrication techniques. The methods, systems, and apparatuses disclosed herein may be used to create custom thermoplastic microfluidic devices, which can be used to conduct a variety of scientific tasks useful in industries including biotech, pharmaceuticals, and diagnostics.

Lab-on-chip companies typically use one or more of the following methods for fabricating chips: soft lithography, lamination, micromachining, injection molding, and hot embossing. As described below, these processes may be cost-prohibitive and may require weeks to months of time for manufacturing, making it difficult to rapidly generate new chips or alter existing designs.

Soft lithography is a process of assembling microfluidic devices that includes techniques similar to those used in semiconductor fabrication. In a typical process, a layer of photoresist (e.g., SU-8) may be formed on a silicon wafer. The layer of photoresist may be tens to hundreds of microns thick. The photoresist-coated silicon wafer may be developed in UV light under a photomask in the design of the desired microfluidic features. The exposed photoresist may harden and the remaining unexposed photoresist may be dissolved off the silicon wafer. The resulting silicon “master” may exhibit protruding boss microstructures. Typically, more than one device design may be formed on a wafer. A layer of liquid silicone (e.g., polydimethylsiloxane silicone (“PDMS”)) may be poured over the silicon master and cured at high temperature. The silicone, which may be solid and rubbery after curing, may then be peeled away from the wafer, revealing embossed microfeatures. The individual device designs may be sliced from the silicon master with a craft blade. The embossed microstructures may be “capped” by sealing the silicone piece to either a microscope slide or another layer of silicone. Each silicon wafer may typically support a few hundred pours of PDMS before the photoresist microbosses begin to degrade.

Using PDMS is a common and straightforward means of hand-producing units in low volumes, but the resulting devices may have several drawbacks. Critically, PDMS may not be a viable candidate for mass production. Because the material properties of PDMS are quite distinct from those of the thermoplastics that are typically used in mass-production, results of experiments conducted with PDMS devices may not be representative of results achievable at scale. This may create problems as teams try to transition from phases of experimentation and prototyping to those of commercialization and volume.

Lamination is a process by which several layers of a device are cut independently and bonded together in a stack to form microfluidic features. A simple laminate may include an interface layer, a flow layer, and a sealing layer. The layers may be made from thermoplastics or glass and bonded using double-sided adhesive tape. In some examples, laser-cut adhesive tape may be used both as a flow layer and to bond the interface and sealing layers.

Lamination is an attractive method for making microfluidic devices because the materials are inexpensive, fabrication is quick and easy, and it is possible to use materials that provide optical access. However, the process may also have several drawbacks. Though adhesive tapes make bonding quick and easy, tapes may absorb chemicals and particles and may leak adhesive into the channels during use. In addition, devices that are bonded using adhesive tape generally cannot withstand high pressures and may be susceptible to bursting.

Micromachining is a means of subtractive manufacturing in which material is removed to form microfluidic features. This may be done by micro-milling or by laser etching. Though this process affords high accuracy and precision, resulting surface finishes may be uneven, impacting flow dynamics of downstream experiments. Additionally, production time is directly proportional to the number of devices made. At medium and high volumes, micromachining may not be cost-effective or time-effective.

Injection molding is a common method of mass-production for various devices. Molten plastic may be injected into mold cavities, where it cools and hardens to the shape of the cavity. Molds are generally made of machined and polished metal. In the case of microfluidic devices, which may require high-precision micromachining, molds may cost tens of thousands of dollars. Therefore, the high fixed cost of injection molding may only be economical at large order volumes.

Hot embossing is a thermal process where a stamp with raised features is pressed into a thermoplastic sheet heated slightly above its glass transition temperature. The glass transition temperature is a range of temperature in which a thermoplastic changes from a glassy state into a viscous state. As the stamp is pressed into the plastic, the plastic may slowly flow and the features of the stamp may be imprinted into its surface. The plastic and stamp may then be cooled to just below the glass transition temperature, where the plastic sheet hardens and returns to a glassy state. The tool and the plastic sheet may then be separated, yielding a rigid plastic sheet with imprinted microfluidic features. This method may reproduce microfluidic features with good fidelity.

In a typical hot embossing process, a blank thermoplastic sheet may be compressed between a fixed plate and a mold that contains an inverse of the geometry desired in the finished part. While the sheet is compressed, the temperature of the mold may be increased, and the thermoplastic sheet may take the shape of the mold.

Typically, the mold for this process is produced by photolithography, as described above. Alternatively, a mold can be produced by micro Computer Numerical Control (CNC) machining. However, both mold production techniques are prohibitively expensive and generally require weeks for production.

After an embossing, lamination, or micromachining process, devices must be sealed. This proves a difficult challenge in microfluidic device production as the manufacture must ensure the entire device is fluid tight, while also avoiding deforming or contaminating the microfeatures in the chip. Thermal diffusion bonding may meet these requirements. The thermal diffusion process works by heating a target sheet and a cover sheet of the same material to just below the glass transition temperature and applying a strong clamping force. The process may have similar requirements to hot embossing.

The following description includes a novel hot embossing process that addresses the shortcomings of the existing fabrication techniques described above. Using a 3D printed microfeature mold from a thermally stable photopolymer, the process disclosed herein may be faster and more cost-effective than the techniques described above.

In contrast to conventional molds used for hot embossing, the microfeature mold in the present disclosure may be formed from a thermally stable photopolymer using a 3D printing process. Suitable thermally stable photopolymers may include, for example, Accura® Bluestone™ distributed by 3D Systems Corporation or High Temp Resin distributed by Formlabs. The thermally stable photopolymer used to form the microfeature mold may have a heat deflection temperature that is able to withstand the high temperatures necessary in the hot embossing process. In an example, the heat deflection temperature may be higher than a glass transition temperature of a thermoplastic sheet used to form a device, as described below. For example, the thermally stable photopolymer used to form the microfeature mold may have a heat deflection temperature above 200° C.

Producing the microfeature mold via a 3D printing process may be more efficient than the conventional methods described above and may allow for the production of parts in less than a day as compared to weeks. Additionally, the flexible nature of the 3D printing process may provide many additional options for the design of the microfeature mold that may be helpful in the production process. For example, one or more core alignment features may be printed directly into one half of a microfeature mold. The one or more core alignment features may mate with one or more cavity alignment features that are printed directly into a second half of the microfeature mold. These features are described in detail below.

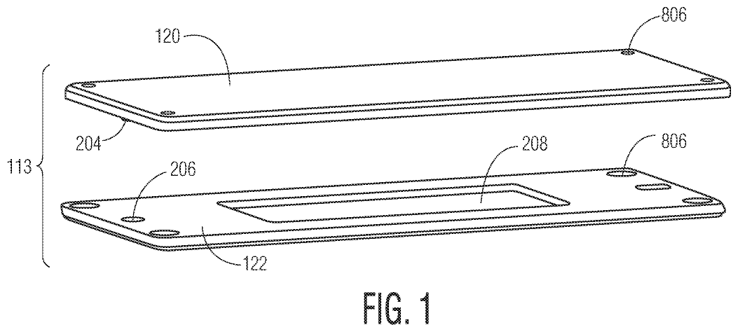

Referring now to FIG. 1, a perspective view of a microfeature mold 113 formed using a 3D printing process is shown. The microfeature mold 113 may include two halves. A first half may be cavity tooling 122 and a second half may be core tooling 120. Each of the cavity tooling 122 and the core tooling 120 may include one or more protrusions and recesses formed during the 3D printing process.

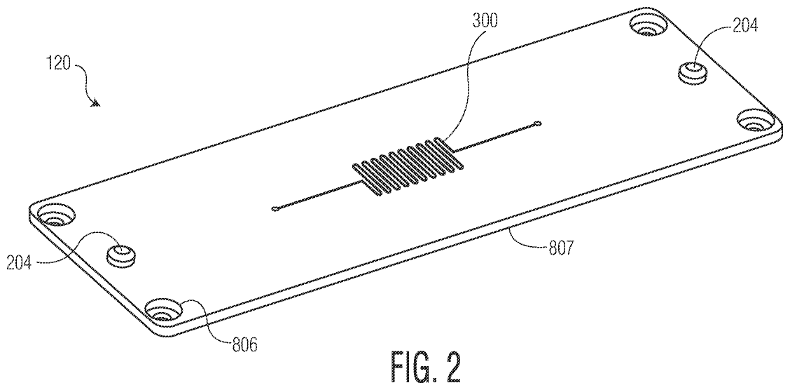

The cavity tooling 122 may include one or more cavity alignment features 206, one or more fastener holes 806, and a recess 208. The core tooling 120 may contain one or more core alignment features 204, the one or more fastener holes 806, and a microfeature pattern 300 (shown below in FIG. 2).

The one more fastener holes 806 may enable the core tooling 120 and the cavity tooling 122 to be attached to another component, such as a heating element, as described below. The one or more core alignment features 204 may mate with the one or more cavity alignment features 206 such that the core tooling 120 and the cavity tooling 122 are precisely aligned. The core tooling 120 may contain any number of core alignment features 204 and the cavity tooling 122 may include a corresponding number of cavity alignment features 204. It should be noted that FIG. 1 shows the one or more core alignment features 204 as pegs and the one or more cavity alignment features 206 as holes, but any type of arrangement may be used. The recess 208 may enable a precise alignment of a thermoplastic sheet with the core tooling 120 when installed by a user, as described in detail below.

Referring now to FIG. 2, a perspective view of the core tooling 120 is shown. FIG. 2 shows an underside of the core tooling 120, which is configured to align with an upper side of the cavity tooling 122. The core tooling 120 may include the one or more core alignment features 204, the one or more fastener holes 806, one or more locations for temperature measurement 807, and the microfeature pattern 300. The microfeature pattern 300 may be the inverse of desired microfeatures to be formed on a microfluidic chip. For example, if a recess is desired on a microfluidic chip, a proud microfeature pattern 300 may be formed on the core tooling 120.

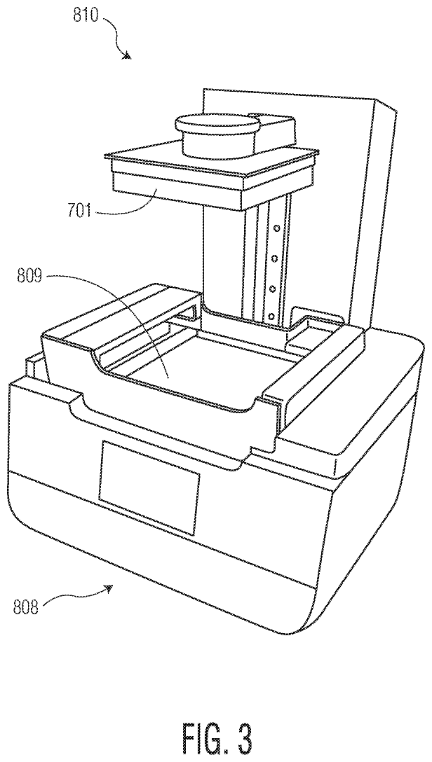

Referring now to FIG. 3, an illustration of a 3D printer 810 that may be used to form the microfeature mold 113 is shown. The 3D printer 810 may be any type of conventional 3D printer used in the art that is capable of 3D printing parts in a thermally stable photopolymer. In an example, the 3D printer 810 be a resin-based 3D printer and may include a resin tank 809, a build platform 701, and an internal optical curing source 808.

To create the microfeature mold 113, the design of a proposed microfluidic chip must be defined. To create a chip with custom geometry, a three dimensional computer-aided-design (CAD) model may be created with a custom microfeature pattern 300 with specified widths, depths, and aspect ratios. The CAD model can be created via any one or more conventional software applications typically used in the art, such as Solidworks®, Pro/ENGINEER®, Onshape®, and CATIA®. The CAD model can be saved in any three dimensional filetype typically used in the art, such as .step, .iges, and .sldprt. Alternatively, designs for a microfluidic chip may be created via any two dimensional CAD program typically used in the art, such as Adobe Illustrator or Inkscape, and the depth of each microfeature may be specified.

A CAD model may be enlarged or shrunk by a necessary amount to account for the difference in thermal expansion between the microfeature mold and a target thermoplastic sheet to ensure microfeatures are reproduced accurately.

Upon successful design in CAD, a three dimensional model may be saved as a stereolithography interface format (.stl) file. Within the software used, adjustments may be made with regards to part orientation, resolution, and support. Once the desired properties for the part have been set, the file may be uploaded directly to the 3D printer. The build platform 701 may be lowered into the resin tank 809 such that there is a predetermined gap between a transparent window on a bottom of the resin tank 809 and the build platform 701. This may result in a thin layer of photopolymer resin remaining between the build platform 701 and the transparent window on the bottom of the resin tank 809. The optical curing source 808 may cure the thin layer of photopolymer resin to the build platform 701 in a pattern according to the design uploaded to the 3D printer. When the first layer is complete, the build platform 701 may be raised by a small increment, and the process may be repeated to form additional layers and build the one or more microfeatures.

The resolution of the 3D printer 810 may vary by its dimension. Features in the same plane as the build platform 701 (planar dimensions) may have higher resolution than features that are orthogonal to the build platform 701 (Z dimension). To optimize feature resolution, tooling may be printed in one of two orientations: flat against the build platform 701 or orthogonal to the build platform 701.

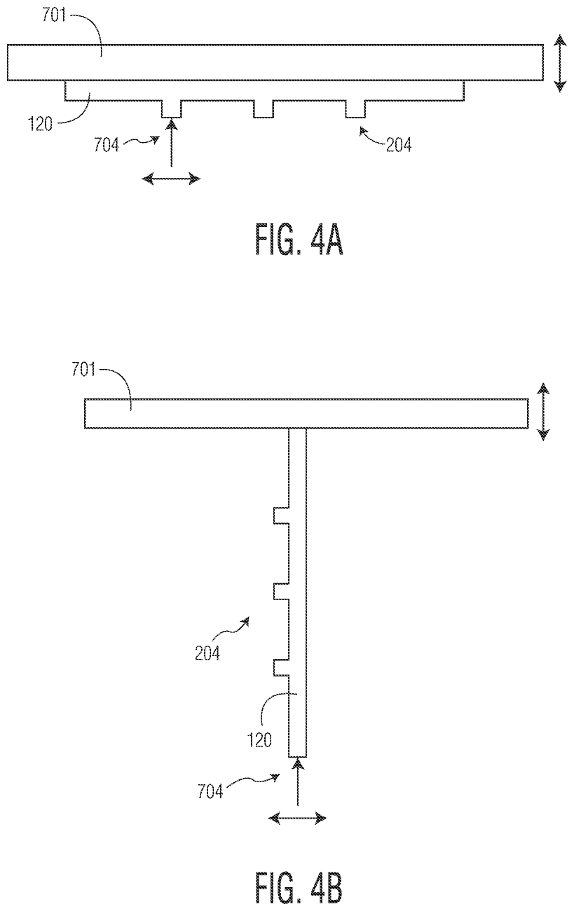

Referring now to FIG. 4A, a side view of the core tooling 120 being 3D printed flat against the build platform 701 is shown. The light source 704 may move side to side (as shown by the arrows) to cure a single layer of the photopolymer resin. After a layer is complete, the build platform 701 may be raised by a small increment, and the process may be repeated. The core tooling 120 may be created layer by layer using this process until the 3D printed component is complete. Upon completion, the build platform 701 may be raised to a high position, at which point it can be removed from the 3D printer 810. The completed core tooling 120 may then be removed from the build platform 701 using common hand tools. In this first orientation, the core tooling 120 may include a microfeature pattern 300 with high-resolution widths. Additionally, the microfeature pattern 300 may have uniform depths and smooth floors. The fidelity of the microfeature pattern 300 depth changes may be a function of the 3D printer's 810 resolution in the Z dimension. The cavity tooling 122 may be formed using a similar process.

Referring now to FIG. 4B, a side view of the core tooling 120 being 3D printed orthogonally to the build platform 701 is shown. The light source 704 may move side to side (as shown by the arrows) to cure a single layer of the photopolymer resin. After a layer is complete, the build platform 701 may be raised by a small increment, and the process may be repeated. The core tooling 120 may be created layer by layer using this process until the 3D printed component is complete. Upon completion, the build platform 701 may be raised to a high position, at which point it can be removed from the 3D printer 810. The completed core tooling 120 may then be removed from the build platform 701 using common hand tools. In this orientation, if the core tooling 120 has microfeatures with varying depths, they may have smoother microfeature floors than if printed in the first orientation. The fidelity of microfeature widths may be a function of the 3D printer's resolution in the Z dimension. The cavity tooling 122 be formed using a similar process.

In another example, components of the 3D printer 810 may be inverted and the build platform 701 may be located within the resin tank 809 and the optical curing source 808 may reside above the resin tank 809. The build platform 701 may be lowered deeper into the resin tank 809 incrementally. A new layer of photopolymer resin may flow in above the cured part, after which it may be cured by the optical curing source 808. This process may be repeated until the part is complete. In some instances, temporary support structures may be printed to stabilize geometry that would otherwise be too fragile or intricate to produce.

Depending on the photopolymer used, the completed part may require post-processing like additional curing in a light curing chamber, or thermal curing in an oven per manufacturer recommendations.

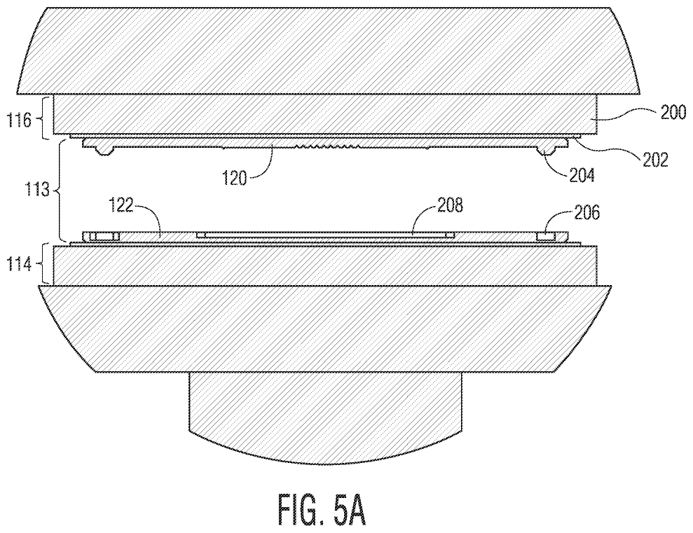

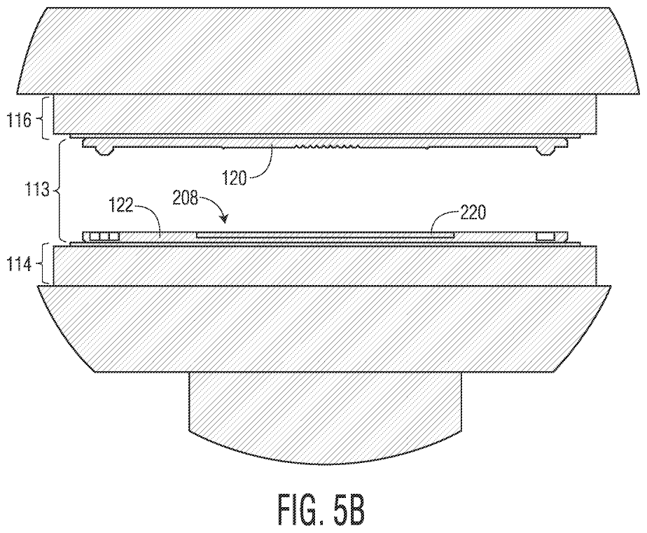

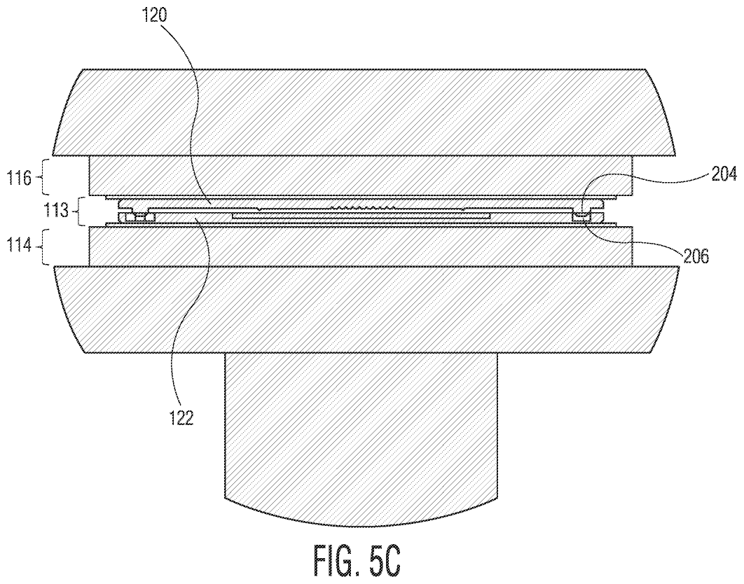

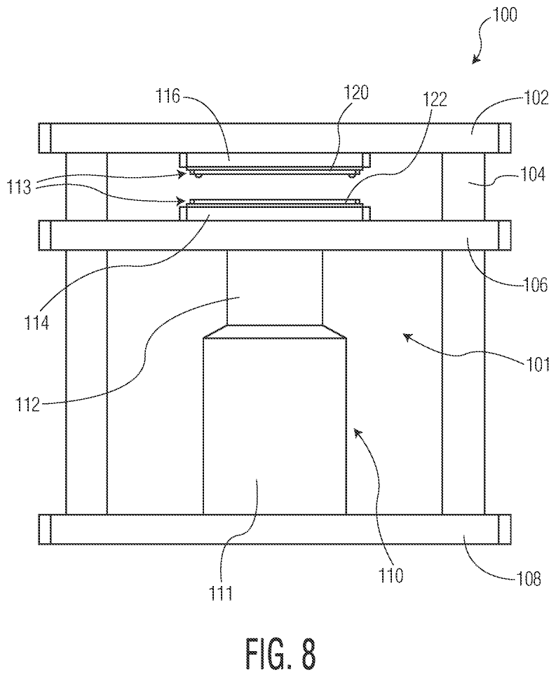

Referring now to FIG. 5A, a front section view of the microfeature mold 113 in an open position inside of a microfeature forming system 100, described below with reference to FIG. 8, is shown. One or more of the core tooling 120 and the cavity tooling 122 may be attached or coupled to a heating assembly via the one more fastener holes 806 (not shown). For example, the cavity tooling 122 may be attached to a lower heating assembly 114 and the core tooling 120 may be attached to an upper heating assembly 116.

The upper heating assembly 116 and the lower heating assembly 114 may each include an insulator 200 and a resistive heater 202. The resistive heater 202 may be composed of a soft silicone material and may have an internal resistive heating element. The soft silicone may provide compliance and may help maintain an even pressure across the microfeature mold 113 when it is compressed. When current is applied to the resistive heater 202, its surface temperature may increase rapidly and the insulator 200 may slow heat transfer to surrounding components.

Referring now to FIG. 5B, a front section view of the microfeature mold 113 in an open position with a thermoplastic sheet 220 inserted into the recess 208 is shown. The thermoplastic sheet 220 may be composed of any type of material used in the art, such as, but not limited to, cyclic olefin copolymers, cyclic olefin polymers, nylon, polyethylene, polypropylene, polycarbonate, styrene-ethylene-butylene-styrene (SEBS), thermoplastic urethanes, and any other material that softens at elevated temperatures. In an example, the thermoplastic sheet 220 may be composed of an acrylic, such as polymethyl methacrylate (“PMMA”). PMMA is an inexpensive polymer that is naturally more hydrophilic than many other options. It has excellent optical transparency but is brittle and more prone to cracking than other thermoplastics. In another example, the thermoplastic sheet 220 may be composed of polystyrene. Polystyrene is typically used in labware for biological applications. It is biocompatible, rigid, low cost and its surface can be easily functionalized.

Referring now to FIG. 5C, a front section view of the microfeature mold 113 in a partially closed position with the thermoplastic sheet 220 inserted is shown. In this position, the one or more core alignment features 204 may successfully mate with the one or more cavity tooling features 206. There may be a small gap maintained between the core tooling 120 and the cavity tooling 122. One or more of the lower heating assembly 114 and the upper heating assembly 116 may then be used to bring one or more of the core tooling 120 and the cavity tooling 122 to a proper forming temperature, which may be just above the glass transition temperature of the thermoplastic sheet 220. The glass transition temperature is the range where the thermoplastic sheet transitions from a solid state to a viscous liquid state.

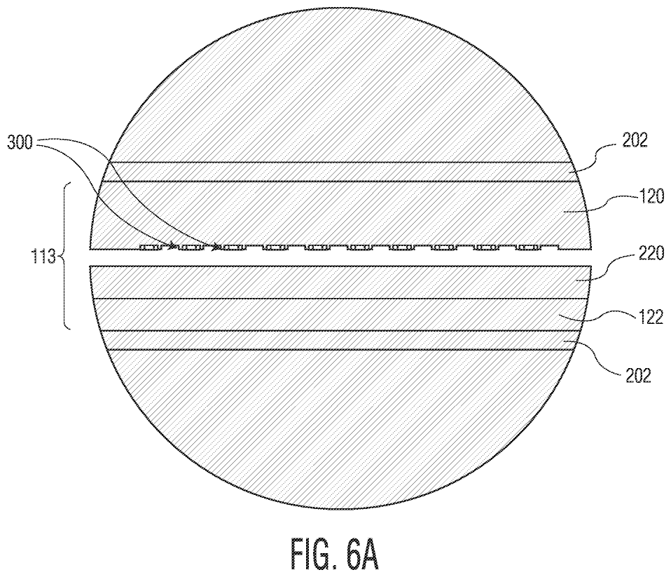

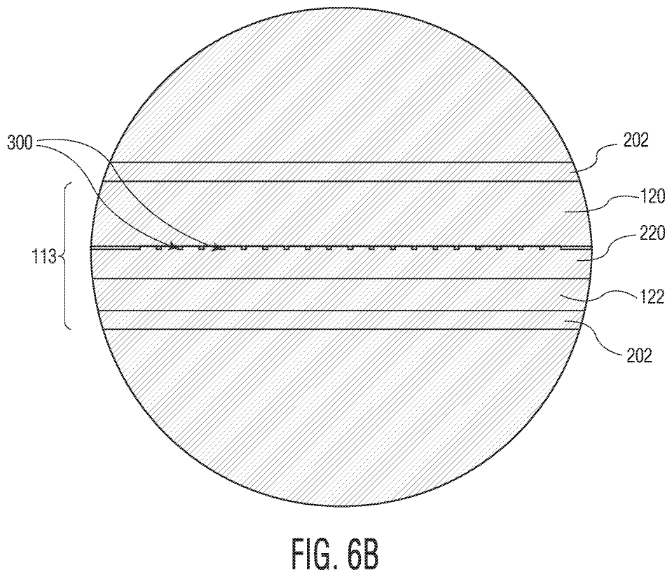

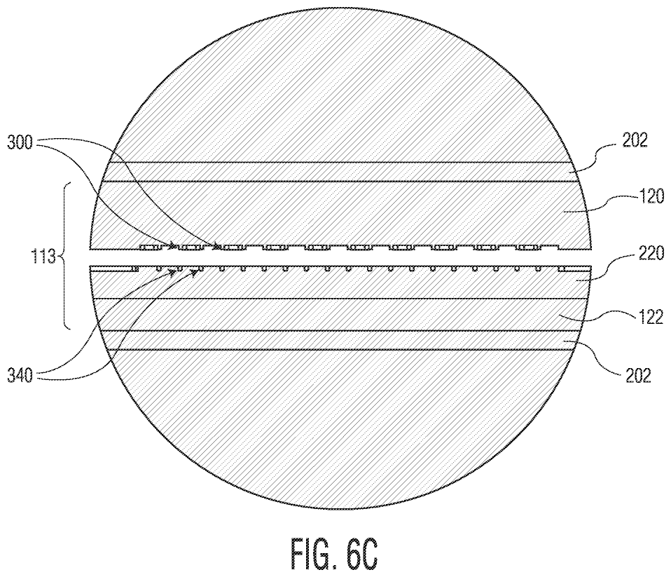

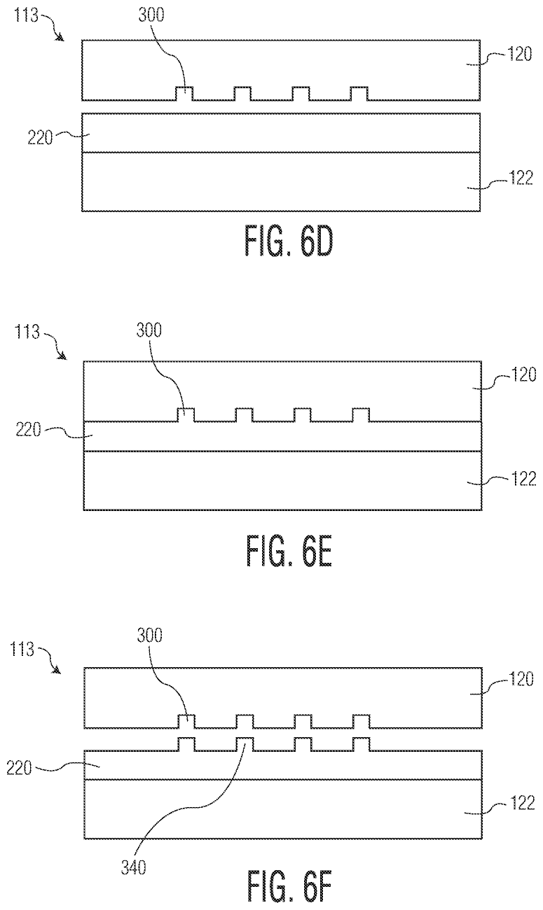

Referring now to FIG. 6A, a magnified view of the microfeature mold 113 in a partially closed position with the thermoplastic sheet 220 inserted is shown. The core tooling 120 may include one or more proud microfeature patterns 300. Once the microfeature mold 113 reaches the forming temperature, a compression apparatus 101 (described below with reference to FIG. 8) may be used to apply force that causes the proud microfeature pattern 300 to sink into the thermoplastic sheet 220 until the first half and the second half of the microfeature mold 113 fully close on one another.

Referring now to FIG. 6B, a magnified view of the microfeature mold 113 in a fully compressed position with the thermoplastic sheet 220 inserted is shown. The amount of force applied and the time required for compression may be dependent on the size and thickness of the thermoplastic sheet and the microfeatures desired. After the proper amount of forming time has elapsed, upper heating assembly 116 and lower heating assembly 114 may be turned off and the microfeature mold may be cooled to temperature below the glass transition temperature of the thermoplastic sheet 220. After cooling, the compression force may be removed and the core tooling 120 and the cavity tooling 122 be separated from one another.

Referring now to FIG. 6C, a magnified view of the microfeature mold 113 in an open position after the molding process is complete is shown. Recessed microfeatures 340 may be formed in the thermoplastic sheet 220. The compression apparatus 101 may be fully retracted and the thermoplastic sheet 220 may be removed.

Referring now to FIG. 6D, a magnified view of another example of the microfeature mold 113 in a partially closed state is shown. In this example, the microfeature mold 113 may include one or more recessed microfeature patterns 300 in, for example, the core tooling 120.

Referring now to FIG. 6E, a magnified view of the microfeature mold 113 in a closed state is shown. One or more halves of the microfluidic mold 113 may be heated to the glass transition temperature of the thermoplastic sheet 220 and the two halves may be compressed on the thermoplastic sheet 220. The thermoplastic sheet 220 may flow into the microfeature pattern 300.

Referring now to FIG. 6F, a magnified view of the microfeature mold 113 in an open state is shown. After the thermoplastic sheet 220 flows into the microfeature pattern 300, the microfeature mold 113 may then be cooled and separated, revealing the thermoplastic sheet 220 with proud microfeatures 340 protruding from its surface. It should be noted that proud and recessed microfeatures may be mixed to achieve desired geometry on a finished product. One or more of the core tooling 120 and the cavity tooling 122, may contain any combination of proud microfeature patterns 300 and one or more recessed microfeature patterns 300.

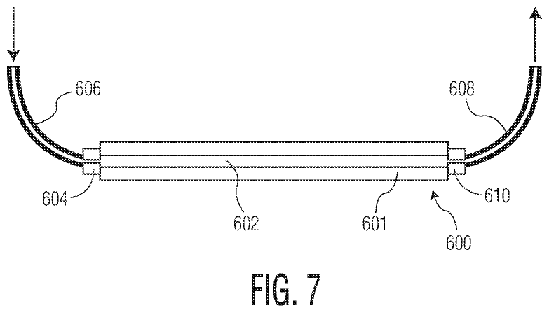

Referring now to FIG. 7, a front section view of an example heating assembly 600 is shown. The heating assembly 600 may be used in one or more of the lower heating assembly 114 and the upper heating assembly 116. The heating assembly 600 may include a heater body 601 made from one or more strong thermally conductive materials, such as steel, aluminum, copper, or brass. The heater body 601 may contain one or more open channels 602 through which fluid may pass. The inlet of each channel 602 may be attached to an inlet fitting 604 and inlet tubing 606. The outlet of each channel 602 may be attached to an outlet fitting 610 and outlet tubing 608. When a heated liquid is pumped through the heating assembly 600 (e.g., at a high flowrate) via the inlet tubing 606 and outlet tubing 608, the heater body may rapidly rise to a similar or same temperature. Conversely, if a cooled liquid is pumped into the heating assembly 600, the temperature of the heater body 601 may rapidly decrease. The heating assembly 600 may be used to quickly heat or cool the microfeature mold 113 to a desired temperature, which may reduce the time required to form microfeatures. It should be noted that different heating elements may be used to raise or lower the temperature of the heating assembly 600. These elements may include kapton, ceramic, cartridge, or Peltier heaters among others.

One or more apparatuses may be used to compress the microfeature mold 113 on the thermoplastic sheet 220. In general, any apparatus that is capable of providing compressive force to the thermoplastic sheet 220 through the microfeature mold 113 may be used. The following description includes a number of exemplary microfeature forming apparatuses.

Referring now to FIG. 8, a front elevational view of a first microfeature forming system 100 is shown. FIG. 8 shows the microfeature forming system 100 in an open state. The microfeature forming system 100 may include a compression apparatus 101. The compression apparatus may include an upper fixed plate 102, which may be rigidly attached to one or more guide rails 104, and a lower fixed plate 108. A sliding plate 106 may be located between the upper fixed plate 102 and the lower fixed plate 108. The sliding plate 106 may slide freely along the one or more guide rails 104. The sliding plate 106 may be attached to a hydraulic cylinder 110. The hydraulic cylinder 110 may include a ram 112 and a base 111.

In an example, the cavity tooling 122 may be attached to the sliding plate 106. The core tooling 120 may be attached to the upper fixed plate 102. The compression apparatus 101 may use the hydraulic cylinder 110 to compress the sliding plate 106 against the upper fixed plate 102. The one or more guide rails 104 may be used to maintain the alignment of the sliding plate 106 relative to the upper fixed plate 102. The compression apparatus 101 may be used to create compressive forces in excess of 100 kilonewtons. The core tooling 120 and the cavity tooling 122 may be inverted so either is located on the upper or lower subassembly of the compression apparatus.

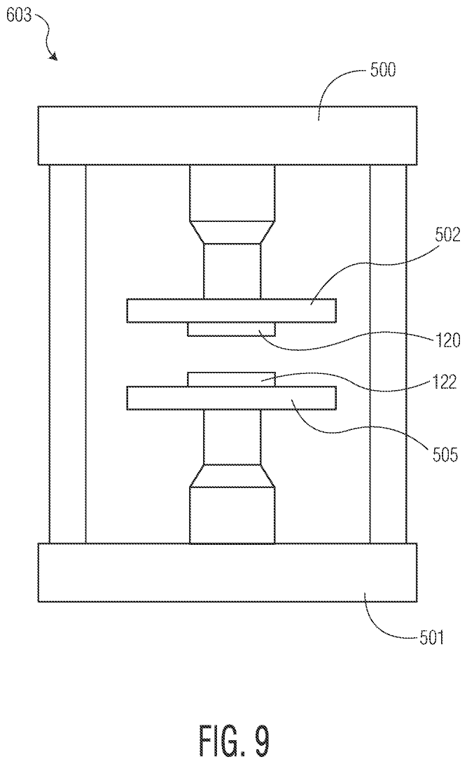

Referring now to FIG. 9, a front elevational view of a second microfeature forming system 603 is shown. FIG. 9 shows the second microfeature forming system 603 in an open state. The second microfeature forming system 603 may include similar elements as those described above with reference to FIG. 8. The microfeature forming system 603 may include a compression apparatus in which the core tooling 120 and the cavity tooling 122 are encapsulated within a framing system 500 and 501. One or more halves of the microfeature mold 113 may be heated via heating assemblies 502 and 505, which may similar to the heating assemblies described above. The two halves of the microfeature mold 113 may be compressed together simultaneously via separate hydraulic cylinders 110. The core tooling 120 and the cavity tooling 122 may be inverted so either is located on the upper or lower subassembly of the compression apparatus.

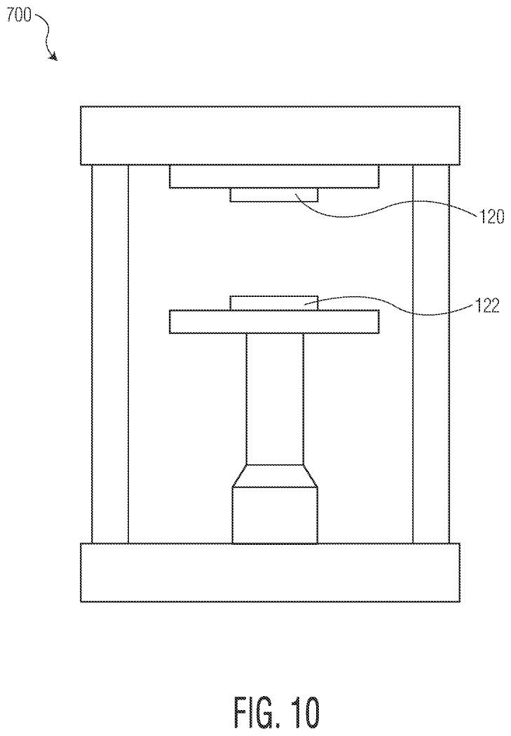

Referring now to FIG. 10, a front elevational view of a third microfeature forming system 700 is shown. FIG. 10 shows the fourth microfeature forming system 700 in an open state. The third microfeature forming system 700 may include similar elements as those described above with reference to FIG. 8. Core tooling 120 may be fixed to a framing system, while cavity tooling 122 may move linearly to achieve compression. In this configuration, the core tooling 120 and the cavity tooling 122 of the microfeature mold 113 may be inverted so either is fixed to the compression apparatus.

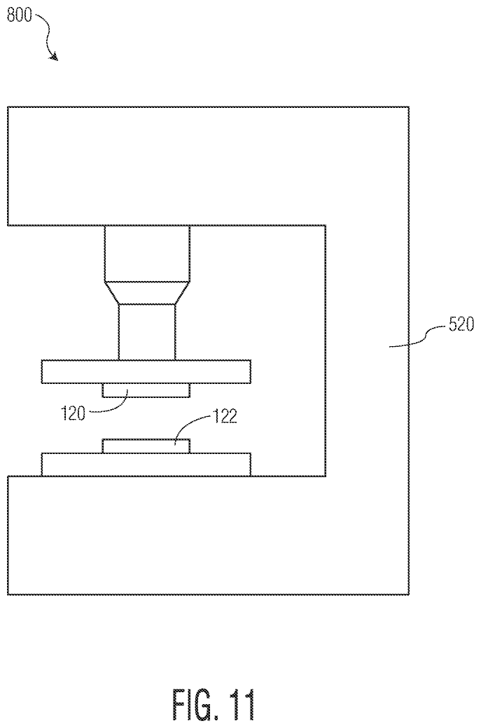

Referring now to FIG. 11, a front elevational view of a fourth microfeature forming system 800 is shown. FIG. 11 shows the fourth microfeature forming system 800 in an open state. The fourth microfeature forming system 800 may include similar elements as those described above with reference to FIG. 8. The fourth microfeature forming system 800 may include a C-shaped structural member 520 to which the cavity tooling 122 is fixed. The core tooling 120 may move linearly to achieve compression. The C-frame shape may minimize obstacles near the embossing site, which may reduce the difficulty of downstream handling processes. In this configuration, the core tooling 120 and the cavity tooling 122 of the microfeature mold 113 may be inverted so either is fixed to the compression apparatus.

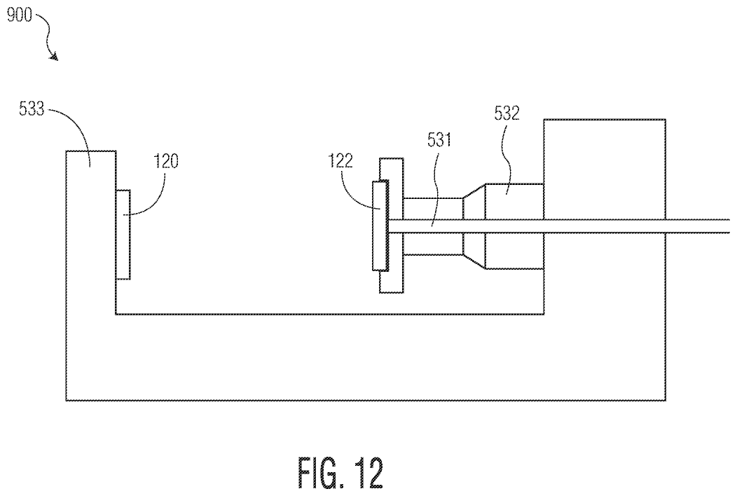

Referring now to FIG. 12, a front elevational view of a fifth microfeature forming system 900 is shown. FIG. 12 shows the fifth microfeature forming system 900 in an open state. The fifth microfeature forming system 900 may include similar elements as those described above with reference to FIG. 8. The core tooling 120 and the cavity tooling 122 may be oriented vertically and compression may be achieved via horizontal displacement. In this configuration, the core tooling 120 may be fastened to the compression system 533, and the cavity tooling 122 may be temporarily affixed to the compression apparatus via, for example, a vacuum 531 or other means. In this configuration, either the core tooling 120, the cavity tooling 122, or both may move.

In each of the microfeature forming systems described above, compression may be achieved with one or more of hydraulics, pneumatics, a rack-and-pinion assembly, mechanical linkages, screw-driven displacement, etc. The rate and scale of compression may be controlled via displacement measurement, force measurement, or a combination of both. In this configuration, the core tooling 120 and the cavity tooling 122 of the microfeature mold 113 may be inverted so either is fixed to the compression apparatus.

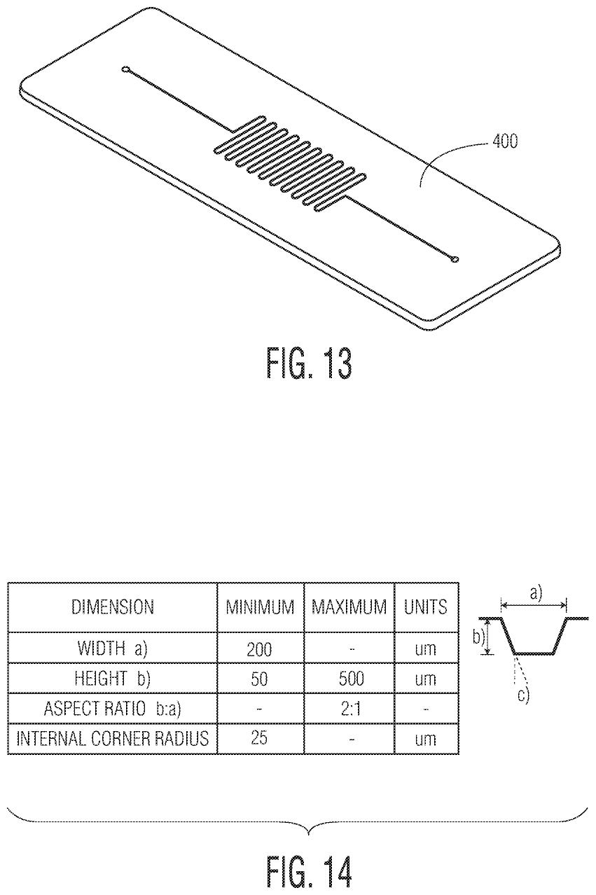

Referring now to FIG. 13, a perspective view of a formed microfluidic chip 400 resulting from the molding process is shown. The microfluidic chip 400 may have any dimensions and any design of microfeatures 340, described above, based on how the microfeature mold 113 and the recess 208 are formed. In an example, the microfluidic chip 400 may have a footprint of 25 mm×75 mm. The microfluidic chip 400 may have a thickness of approximately 400 μm. The microfluidic chip 400 may be capped (e.g., thermally bonded with a similar material having a similar thickness) or open-top (e.g. without capped channels).

Referring now to FIG. 14, a cross section view of microfeatures 340 of the chip 400 is shown. The microfeatures 340 may have any dimensions based on how the microfeature mold 113 and the recess 208 are formed. In an example, the microfeatures 340 may have a minimum width of approximately 200 μm and may have any maximum width so desired. In another example, the microfeatures 340 may have a height ranging from approximately 50 μm to approximately 500 μm. In yet another example, the microfeatures 340 may have an aspect ratio of 2:1 and an internal corner radius of approximately 25 μm. It should be noted that although specific measurements for the microfeatures 340 are provided herein, they are not limiting examples. The microfeatures 340 may be formed having any width, height, and aspect ratio achievable through the 3D printing process.

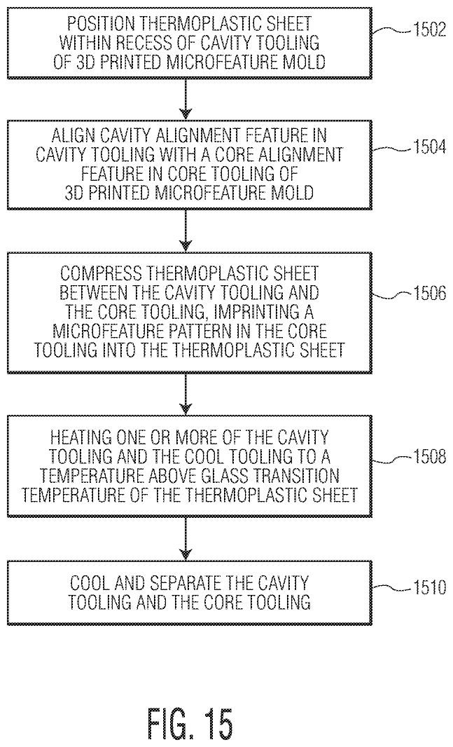

Referring now to FIG. 15, a flowchart illustrating a method of forming the microfluidic chip 400 using the microfeature mold 113 is shown. In step 1502, the thermoplastic sheet 220 may be position within the recess 208 of the cavity tooling 122. In step 1504, the one or more cavity alignment features 206 may be aligned with the one or more core alignment feature 204 of the core tooling 120. In step 1506, the thermoplastic sheet 220 may be compressed, via a compression apparatus, between the cavity tooling 122 and the core tooling 120, such that the microfeature pattern 300 is imprinted on the thermoplastic sheet 220. In step 1508, one or more of the cavity tooling 122 and the core tooling 120 may be heated to a temperature above the glass transition temperature of the thermoplastic sheet 220, such that the compressed thermoplastic sheet 220 flows within the microfeature pattern 300. In step 1510, the cavity tooling 122 and the core tooling 120 may be cooled and separated.

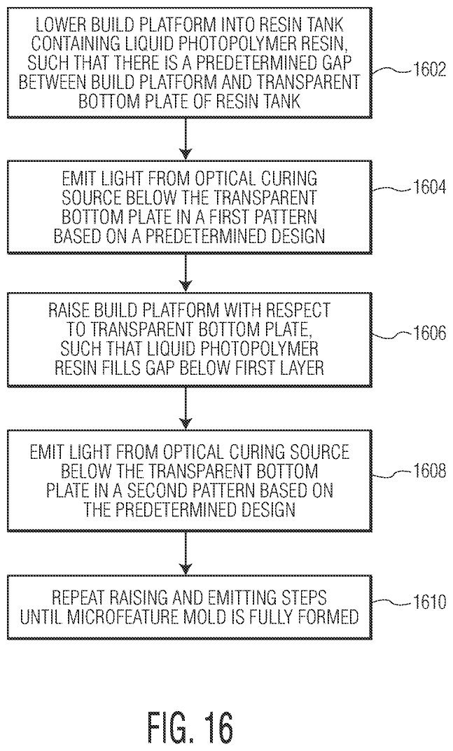

Referring now to FIG. 16, a flowchart illustrating a method of forming the microfeature mold 113 is shown. In step 1602, a build platform may be lowered into a resin tank containing a liquid photopolymer resin, such that the liquid photopolymer resin fills a predetermined gap between a transparent bottom plate of the resin tank and the build platform. In step 1604, a light may be emitted from an optical curing source below the transparent bottom plate in a first pattern based on a predetermined design to cure the liquid photopolymer resin and form a first layer of the microfeature mold, the first layer comprising a thermally stable photopolymer. In step 1606, the build platform may be raised with respect to the transparent bottom plate, such that the liquid photopolymer resin fills a gap between the transparent bottom plate and the first layer of the microfeature mold. In step 1608, the light may be emitted from the optical curing source in a second pattern based on the predetermined design to cure the liquid photopolymer resin to and form a second layer of the microfeature mold, the second layer comprising the thermally stable photopolymer. In step 1610, the raising and emitting steps may be repeated until the microfeature mold is fully formed.

The process described above may be faster, more versatile, and more repeatable than conventional processes used to form microfluidic devices. The microfeature forming system 100 may be easily adjustable for difference designs and since the 3D printing process is more precise than conventional methods, can create microfeatures with: small sizes, large sizes, varying Z-dimension, high or low aspect ratios, good optical clarity, and sharp internal corners. Resulting devices may be composed of thermoplastic materials and may have low auto-fluorescence, low gas permeability, and precise dimensions. In addition, the microfeature forming system 100 is self-aligning, representative of high-volume manufacturing, compatible with automation, and can be scaled so it is cost effective for a small to medium quantity of parts.

Although features and elements are described above in particular combinations, one of ordinary skill in the art will appreciate that each feature or element can be used alone or in any combination with the other features and elements.

What is claimed is:

1. A system for forming microfeatures on a microfluidic chip, the system comprising:
a microfeature mold comprising a three-dimensional printed thermally stable photopolymer;
a first half of the microfeature mold comprising a recess and a cavity alignment feature, the recess configured to hold a thermoplastic sheet, the thermoplastic sheet comprising a material that softens at a glass transition temperature;
a second half of the microfeature mold comprising a microfeature pattern of one or more of proud and recessed microfeatures and a core alignment feature, the core alignment feature aligned with the cavity alignment feature; and
a compression apparatus coupled to one or more of the first half of the microfeature mold and the second half of the microfeature mold.

2. The system of claim 1, further comprising:
a fixed upper plate coupled to a fixed lower plate by guide rails; and
a sliding plate configured to slide freely between the fixed lower plate and the fixed upper plate along the guide rails.

3. The system of claim 2, wherein the first half of the microfeature mold is attached to the sliding plate and the second half of the microfeature mold is attached to the fixed upper plate.

4. The system of claim 3, wherein the compression apparatus is coupled to the fixed lower plate and the sliding plate and the compression apparatus configured to move the sliding plate towards the fixed upper plate such that the first half of the microfeature mold and the second half of the microfeature mold are compressed together.

5. The system of claim 1, further comprising:
a lower heating assembly coupled to the first half of the microfeature mold, the lower heating assembly comprising an insulator and a resistive heater made of a soft silicone material and an internal resistive heating element configured to heat up to, at least, the glass transition temperature; and
an upper heating assembly coupled to the second half of the microfeature mold, the upper heating assembly comprising an insulator and a resistive heater made of a soft silicone material and an internal resistive heating element configured to heat up to, at least, the glass transition temperature.

6. The system of claim 1, wherein the core alignment feature comprises a peg and the cavity alignment feature comprises as hole.

7. The system of claim 1, wherein the compression apparatus is configured to compress the thermoplastic sheet between the first half of the microfeature mold and the second half of the microfeature mold.

8. The system of claim 1, wherein the thermally stable photopolymer has a heat deflection temperature higher than the glass transition temperature.

9. A method of forming microfeatures in a chip, the method comprising:
positioning a thermoplastic sheet within a recess of a first half of a microfeature mold comprising a three-dimensional printed thermally stable photopolymer, the thermoplastic sheet comprising a material that softens at a glass transition temperature;
aligning a cavity alignment feature of the first half of the microfeature mold with a core alignment feature of a second half of the microfeature mold;
compressing, via a compression apparatus, the thermoplastic sheet between the first half of the microfeature mold and the second half of the microfeature mold, such that a microfeature pattern of the second half of the microfeature mold is imprinted on the thermoplastic sheet, the microfeature pattern comprising one or more of proud and recessed microfeatures; and
heating one or more of the first half of the microfeature mold and the second half of the microfeature mold to, at least, the glass transition temperature of the thermoplastic sheet, such that the compressed thermoplastic sheet flows within the microfeature pattern.

10. The method of claim 9, wherein the first half of the microfeature mold is attached to a sliding plate and the second half of the microfeature mold is attached to a fixed upper plate, wherein the sliding plate is configured to slide freely between the fixed upper plate and a fixed lower plate along guide rails.

11. The method of claim 10, wherein the compression apparatus is coupled to the fixed lower plate and the sliding plate and the compression apparatus configured to move the sliding plate towards the fixed upper plate such that the first half of the microfeature mold and the second half of the microfeature mold are compressed together.

12. The method of claim 9, wherein the first half of the microfeature mold is coupled to a lower heating assembly comprising an insulator and a resistive heater made of a soft silicone material and an internal resistive heating element configured to heat up to, at least, the glass transition temperature.

13. The method of claim 9, wherein the wherein the second half of the microfeature mold is coupled to an upper heating assembly comprising an insulator and a resistive heater made of a soft silicone material and an internal resistive heating element configured to heat up to, at least, the glass transition temperature.

14. The method of claim 9, wherein the core alignment feature comprises a peg and the cavity alignment feature comprises a hole.

15. The method of claim 9, wherein the thermally stable photopolymer has a heat deflection temperature higher than the glass transition temperature.

16. A three-dimensional printing method of forming a microfeature mold, the method comprising:
lowering a build platform into a resin tank containing a liquid photopolymer resin, such that the liquid photopolymer resin fills a predetermined gap between a transparent bottom plate of the resin tank and the build platform;
emitting a light from an optical curing source below the transparent bottom plate in a first pattern based on a predetermined design to cure the liquid photopolymer resin and form a first layer of the microfeature mold, the first layer comprising a thermally stable photopolymer;
raising the build platform with respect to the transparent bottom plate, such that the liquid photopolymer resin fills a gap between the transparent bottom plate and the first layer of the microfeature mold;
emitting the light from the optical curing source in a second pattern based on the predetermined design to cure the liquid photopolymer resin to and form a second layer of the microfeature mold, the second layer comprising the thermally stable photopolymer; and
repeating the raising and emitting steps until the microfeature mold is fully formed.

17. The method of claim 16, wherein the microfeature mold is formed parallel to the build plate.

18. The method of claim 16, wherein the microfeature mold is formed orthogonal to the build plate.

19. The method of claim 16, wherein the microfeature mold comprises a recess and a cavity alignment feature, the recess configured to hold a thermoplastic sheet.

20. The method of claim 16, wherein the microfeature mold comprises a microfeature pattern and a core alignment feature.
